(19) United States
(12) Patent Application Publication
(10) Pub. No.: US 2009/0185113 A1
(43) Pub. Date: Jul. 23, 2009

(54) Color Filter Module and Device of Having the Same

(75) Inventor: Yi-Wen CHUNG, Tainan City (TW)

Correspondence Address: ALSTON & BIRD LLP, BANK OF AMERICA PLAZA, 101 SOUTH TRYON STREET, SUITE 4000, CHARLOTTE, NC, 28280-4000, US

(73) Assignee: INDUSTRIAL TECHNOLOGY RESEARCH INSTITUTE, Hsinchu (TW)

(21) Appl. No.: 12/108,476

(22) Filed: Apr. 23, 2008

Related U.S. Application Data
(60) Provisional application No. 61/022,800, filed on Jan. 22, 2008.

(51) Int. Cl. G02F 1/1335; G02B 5/22

(52) U.S. Cl. 349/106; 359/891

(57) ABSTRACT

A color filter module comprising a substrate, a transparent conductive layer on the substrate, a set of first particles of a first diameter disposed on first regions of the transparent conductive layer, the first diameter allowing the first regions to provide a first light emission with a first wavelength, a set of second particles of a second diameter disposed on second regions of the transparent conductive layer, the second diameter allowing the second regions to provide a second light emission with a second wavelength, and a set of third particles of a third diameter disposed on third regions of the transparent conductive layer, the third diameter allowing the third regions to provide a third light emission with a third wavelength.

### CROSS-REFERENCE TO RELATED APPLICATIONS

This application is related to and hereby claims the priority benefit of U.S. Provisional Application No. 61/022,800, filed Jan. 22, 2008, incorporated herein by reference in its entirety.

### BACKGROUND OF THE INVENTION

This invention generally relates to a color filter module and, more particularly, to a display device having the same.

A liquid crystal display may generally include a backlight module, a liquid crystal module, a thin film transistor (TFT) array and a color filter module. An adjustable electrical field may change the orientation of liquid crystal molecules in the liquid crystal module so as to control incident light from the backlight and in turn the illumination of color pixels of a color filter module. FIG. 1A is a schematic diagram illustrating a structure of a conventional liquid crystal display (LCD) 10. Referring to FIG. 1A, the LCD 10 may include a lower polarizer 11, an upper polarizer 15, a transparent conductive electrode 12 such as an indium tin oxide (ITO) electrode, a liquid crystal module 13 and a color filter module 14. Referring to the left part of FIG. 1A, which shows an “on” state of the LCD 10, when an electrical field is absent, light emitted from a backlight module (not shown) in a direction shown in an arrowhead may be incident upon and polarized by the lower polarizer 11. The polarized incident light may pass through the first transparent electrode 12 and may be rotated in its propagation direction as it passes through the liquid crystal module 13, which allows the light to pass through the upper polarizer 15 via the color filter module 14.

Referring to the right part of FIG. 1A, which shows an “off” state of the LCD 10, when an electrical field is applied across the transparent conductive electrode 12, the liquid crystal molecules in the liquid crystal module 13 may change in orientation to allow the polarized incident light to pass through the liquid crystal module 13 without significant rotation. The light from the liquid crystal module 13 may then pass through the color filter module 14 but may be blocked by the upper polarizer 15.

The color filter module 14 may include red (R), green (G) and blue (B) filters to separate the light from the upper polarizer 15 into R, G and B lights. FIG. 1B is a schematic diagram illustrating a structure of the color filter 14 shown in FIG. 1A. Referring to FIG. 1B, the color filter 14 may include an ITO layer 141, an over-coating layer 142 for planarization, a block matrix layer 143, a glass substrate 144 and a number of filters 145, which may further include red filters 145R, green filters 145G and blue filters 145B. The color filter 14 may be generally used in conjunction with a backlight source that emits white light. However, with the development of full-color techniques and the increasing interest in image quality, display devices such as LCDs are required to provide a wider color gamut and better chromaticity. It may be desirable to have a color filter that may improve the display quality of an LCD in, for example, color rendering and color richness. Moreover, it may be desirable to have a display device including a light source that may emit light different from white light and may provide improved chromaticity when used in conjunction with the inventive color filter.

### BRIEF SUMMARY OF THE INVENTION

Examples of the present invention may provide a color filter module comprising a substrate, a transparent conductive layer on the substrate, a set of first particles of a first diameter disposed on first regions of the transparent conductive layer, the first diameter allowing the first regions to provide a first light emission with a first wavelength, a set of second particles of a second diameter disposed on second regions of the transparent conductive layer, the second diameter allowing the second regions to provide a second light emission with a second wavelength, and a set of third particles of a third diameter disposed on third regions of the transparent conductive layer, the third diameter allowing the third regions to provide a third light emission with a third wavelength.

Some examples of the present invention may provide a display device comprising a light source, a first substrate to receive light from the light source, a liquid crystal layer over the first substrate, and a color layer comprising a second substrate, a transparent conductive layer on the second substrate, a set of first particles of a first diameter disposed on first regions of the transparent conductive layer, the first diameter allowing the first regions to provide a first light emission with a first wavelength, a set of second particles of a second diameter disposed on second regions of the transparent conductive layer, the second diameter allowing the second regions to provide a second light emission with a second wavelength, and a set of third particles of a third diameter disposed on third regions of the transparent conductive layer, the third diameter allowing the third regions to provide a third light emission with a third wavelength.

Examples of the present invention may also provide a display device comprising a light emission layer, a thin film transistor layer over the light emission layer, a liquid crystal layer over the thin film transistor layer, and a color layer comprising a substrate, a transparent conductive layer on the substrate, a set of first particles of a first diameter disposed on first regions of the transparent conductive layer, the first diameter allowing the first regions to provide a first light emission with a first wavelength, a set of second particles of a second diameter disposed on second regions of the transparent conductive layer, the second diameter allowing the second regions to provide a second light emission with a second wavelength, and a set of third particles of a third diameter disposed on third regions of the transparent conductive layer, the third diameter allowing the third regions to provide a third light emission with a third wavelength.

It is to be understood that both the foregoing general description and the following detailed description are exemplary and explanatory only and are not restrictive of the invention, as claimed.

### BRIEF DESCRIPTION OF THE SEVERAL VIEWS OF THE DRAWINGS

The foregoing summary, as well as the following detailed description of the invention, will be better understood when read in conjunction with the appended, exemplary drawings. It should be understood, however, that the invention is not limited to the precise arrangements and instrumentalities shown.

In the drawings:

FIG. 1A is a schematic diagram illustrating a structure of a conventional liquid crystal display;

FIG. 1B is a schematic diagram illustrating a structure of the color filter shown in FIG. 1A;

FIG. 2A is a diagram of an exemplary color filter shown from a cross-sectional view and a top planar view;

FIGS. 2B and 2C are schematic diagrams illustrating patterns of the color pixels in the color filter illustrated in FIG. 2A;

FIG. 3 is a schematic diagram showing wavelength ranges of nanoparticles of compounds across a light spectrum;

FIGS. 4A to 4C are schematic diagrams illustrating an electrophoretic depositing mechanism for forming a color filter module in accordance with one example of the present invention;

FIGS. 5A to 5D are diagrams illustrating a method of forming a color filter using electrophoretic deposition shown from a cross-sectional view and a top planar view;

FIG. 6A is a cross-sectional view illustrating a display device in accordance with an example of the present invention;

FIG. 6B is a cross-sectional view illustrating a display device in accordance with another example of the present invention; and

FIG. 6C is a schematic diagram illustrating a color layer shown in FIG. 5B in accordance with an example of the present invention.

### DETAILED DESCRIPTION OF THE INVENTION

Reference will now be made in detail to the present examples of the invention illustrated in the accompanying drawings. Wherever possible, the same reference numbers will be used throughout the drawings to refer to the same or like portions.

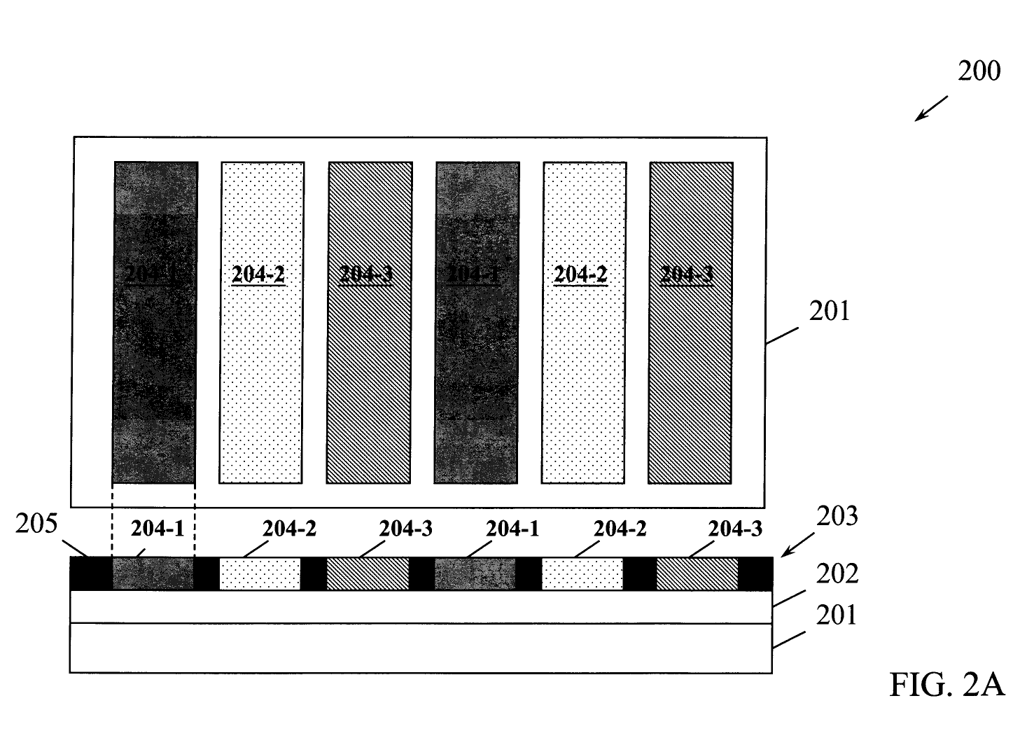

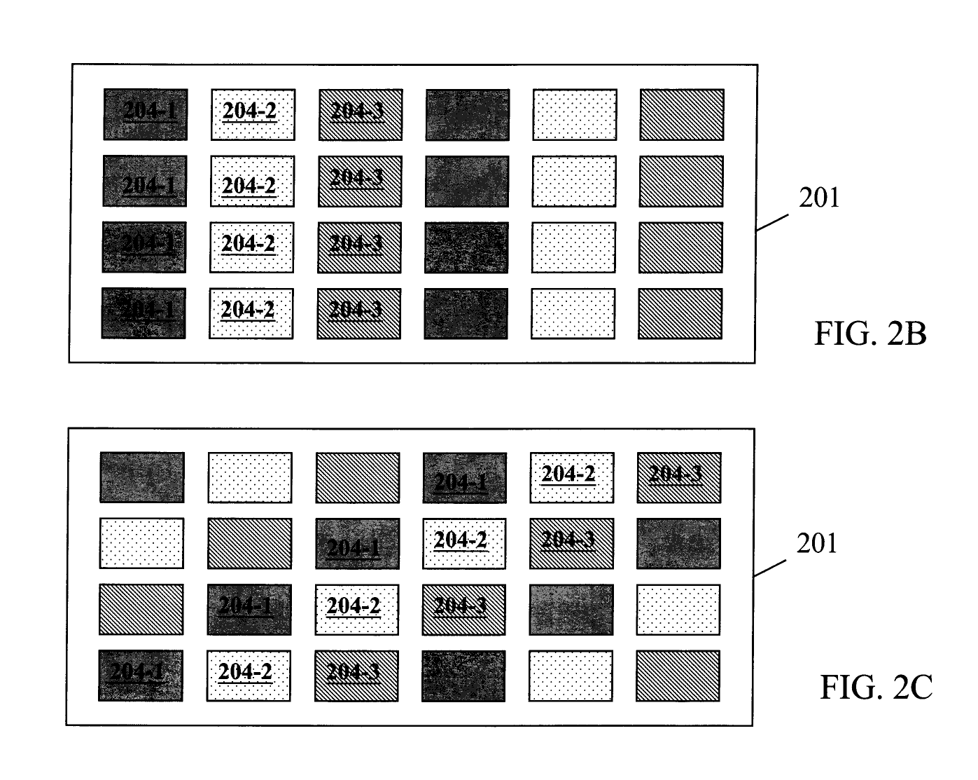

FIG. 2A is a diagram of an exemplary color filter 200 shown from a cross-sectional view and a top planar view. Referring to FIG. 2A, the color filter 200 may include a substrate 201, a transparent conductive layer 202 and a color layer 203. The substrate 201 may include a glass substrate or a flexible substrate. The transparent conductive layer 202 may include one of an indium tin oxide (ITO) film, an indium zinc oxide (IZO) film and a metal film. The color layer 203 may include a number of color pixels 204-1, 204-2 and 204-3 separated from one another by a black matrix material 205. Each of the color pixels 204-1 to 204-3 may include particles on the nanometer (nm) order (hereinafter the “nanoparticles”). The nanoparticles in the color pixels 204-1 to 204-3 may each exhibit a specific color. Furthermore, the nanoparticles in the color pixels 204-1 to 204-3 may each provide a light emission or the specific color due to photoluminescence. In one example, the color pixels 204-1 to 204-3 may respectively provide a red (R) light emission, a green (G) light emission and a blue (B) light emission so that the color filter 200 may provide a first set of color, that is, R, G and B. In another example, the color filter 200 may provide a second set of color such as magenta, cyan and yellow.

Nano-scale particles or nanoparticles may observe the quantum confinement effects. Quantum confinement may refer to a situation when electrons and holes in a semiconductor are confined by a potential well in a one-dimensional (1D) quantum well, two-dimensional (2D) quantum wire or three-dimensional (3D) quantum dot. That is, quantum confinement may occur when one or more of the dimensions of a nanocrystal is made very small so that it approaches the size of an excitation in bulk crystal, called the Bohr excitation radius. Light emission from bulk (macroscopic) semiconductors such as LEDs results from exciting the semiconductor either electrically or by irradiating light on it, creating electron-hole pairs which, when they recombine, emit light. The energy, and therefore the wavelength, of the emitted light is governed by the composition of the semiconductor material. Furthermore, the color of the emitted light is a function of the size of the nanoparticles.

The color layer 203 in one example may range from approximately 0.1 to 10 micrometers (um) in thickness. The color pixels 204-1 to 204-3 in the present example may be arranged in a first pattern, as illustrated in the top planar view, wherein the first color pixel 204-1 configured to provide a first-color light emission may extend in parallel with the second color pixel 204-2 configured to provide a second-color light emission, which in turn may extend in parallel with the third color pixel 204-3 configured to provide a third-color light emission. Furthermore, the black matrix material 205, which serves as an optical absorber the color filter 200, may increase contrast of the color filter 200. In one example, the black matrix 205 may include but is not limited to chromium (Cr) and black resin.

FIGS. 2B and 2C are schematic diagrams illustrating patterns of the color pixels 204-1 to 204-3 in the color filter 200 illustrated in FIG. 2A. Referring to FIG. 2B, the color pixels 204-1 to 204-3 may be arranged in an array in a second pattern. Specifically, a number of first color pixels 204-1 configured to provide the first-light emission may be arranged in columns. Similarly, a number of second color pixels 204-2 configured to provide the second-color light emission and a number of third color pixels 204-3 configured to provide the third-color light emission may each be arranged in columns.

Referring to FIG. 2C, the color pixels 204-1 to 204-3 may be arranged in an array in a third pattern. Specifically, a number of first color pixels 204-1 configured to provide the first-light emission may extend diagonally across the color layer 203. Similarly, a number of second color pixels 204-2 configured to provide the second-color light emission and a number of third color pixels 204-3 configured to provide the third-color light emission may each extend diagonally across the color layer 203.

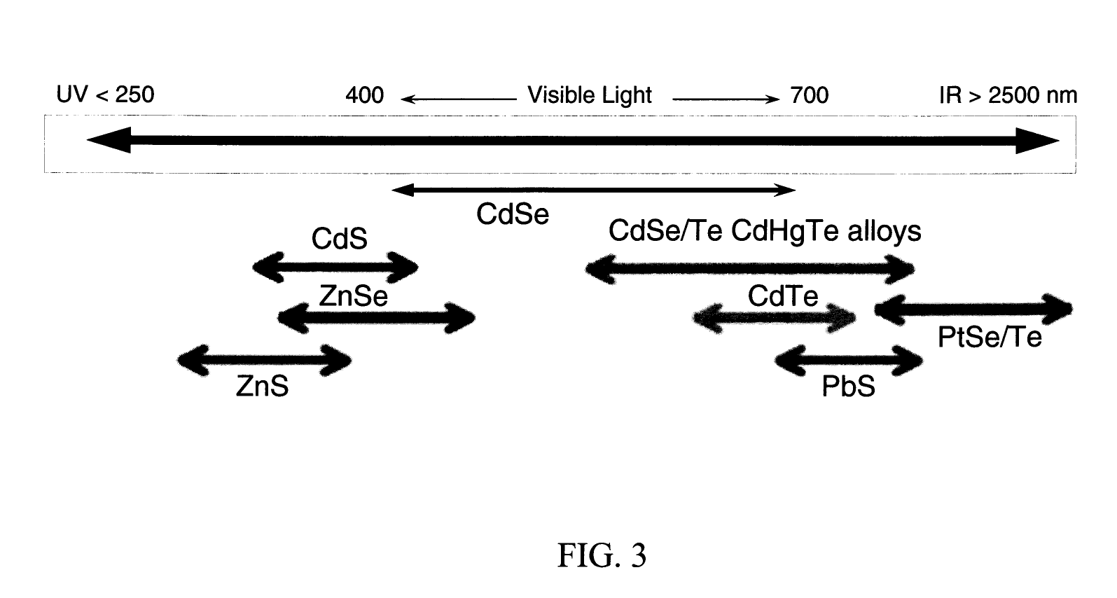

FIG. 3 is a schematic diagram showing wavelength ranges of nanoparticles of compounds across a light spectrum. Referring to FIG. 3, nanoparticles available for the present invention may come from II-VI and III-V compounds, which may include but are not limited to cadmium selenide (CdSe), cadmium sulfide (CdS), zinc selenide (ZnSe), zinc sulfide (ZnS), cadmium telluride (CdTe), platinum selenide (PtSe) and lead sulfide (PbS). Furthermore, III-V compounds not shown in FIG. 3, such as indium arsenide (InAs) and indium phosphide (InP), and core/shell II-VI and III-V compounds such as PtSe/Te, CdSe/Te, CdSe/ZnSe and CdSe/CdS may also serve as the source of the available nanoparticles.

Nanoparticles from the above-mentioned II-VI and III-V compounds may exhibit different wavelengths at different sizes. For nanoparticles of a same material, the wavelength may increase as their size increases. In one example of the present invention, also referring to FIG. 2A, each of the first, second and third color pixels 204-1, 204-2 and 204-3 of the color filter 200 may provide a light emission with a wavelength range different from each other, which together cover the spectrum of the visible light. The visible light spectrum may include a wavelength range from approximately 400 nm to 700 nm, spreading from the color violet, through blue, green, yellow, orange to the color red. Outside the range are ultraviolet whose wavelength may be smaller than 250 nm and infrared whose wavelength may be greater 2,500 nm. Among the II-VI and III-V compounds, the compound CdSe may exhibit a wavelength range substantially covering the visible light spectrum. Furthermore, if appropriately sized, PbS particles may exhibit the color red and CdS particles may exhibit the color blue.

In accordance with one example of the present invention, different sizes of nanoparticles of a same II-VI or III-V compound, such as cadmium selenium (CdSe), may be used to obtain light emissions of desired wavelengths. For example, the first color pixels 204-1 may include CdSe particles having a first average diameter, the second color pixels 204-2 may include CdSe particles having a second average diameter and the third color pixels 204-3 may include CdSe particles having a third average diameter. In one example, the first average diameter may be approximately 7 nm, the second average diameter may be approximately 5 nm and the third average diameter may be approximately 3 nm. In another example, the first, second and third average diameters may range from approximately 6 to 8 nm, 4 to 6 nm and 2 to 4 nm, respectively.

The wavelength of the first color emission from each of the first color pixels 204-1 may range from approximately 600 to 640 nm, which may cover or correspond to red light in the visible light spectrum. Moreover, the wavelength of the second color emission from each of the second color pixels 204-2 may range from approximately 500 to 570 nm, which may cover or correspond to green light in the visible light spectrum. Furthermore, the wavelength of the third color emission from each of the third color pixels 204-3 may range from approximately 450 to 490 nm, which may cover or correspond to blue light in the visible light spectrum.

In accordance with one example of the present invention, the different-sized CdSe particles in the color pixels 204-1 to 204-3 may be excited by light from a light source with a wavelength ranging from approximately 300 to 400 nm. In another example of the present invention, the wavelength of the light from the light source may range from approximately 330 to 360 nm. Such a wavelength may cover or correspond to blue light or purple light in the visible light spectrum. In other words, the light from the light source may be different from white light, which may include a combination of several wavelengths.

In accordance with other examples of the present invention, the particles in the first, second and third color pixels may be selected from at least one of the II-VI and III-V compounds to provide the desired color-light emissions. For example, the first color pixels 204-1 may include particles from the PbS compound, the second color pixels 204-2 may include particles from the CdSe compound, and the third color pixels 204-3 may include particles from the ZnSe compound.

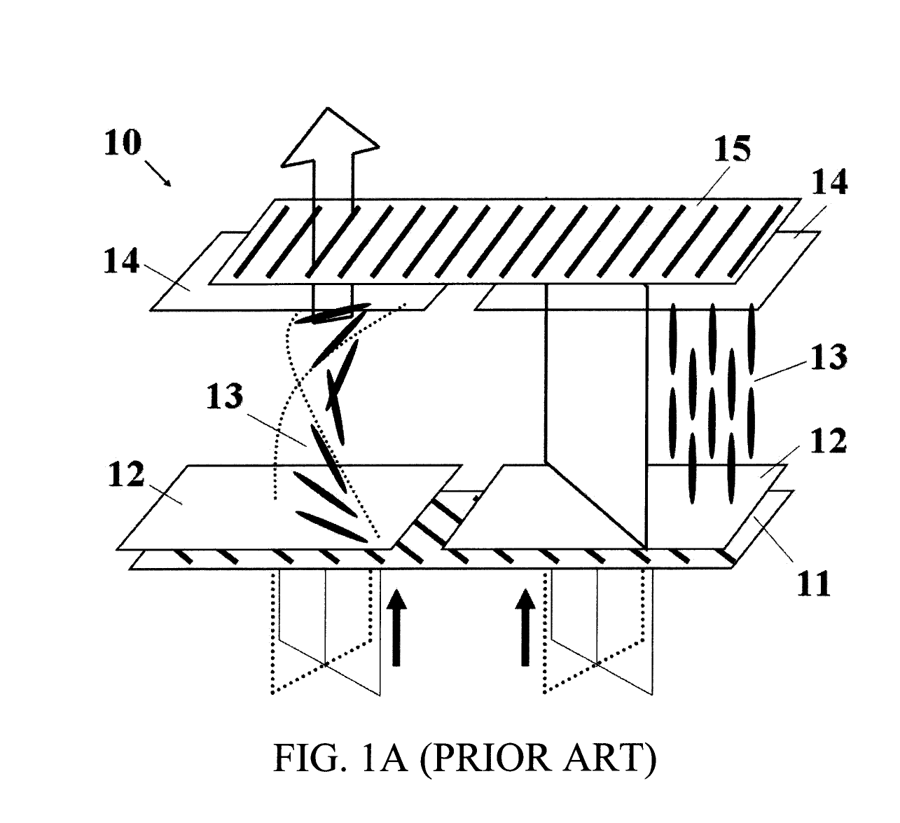

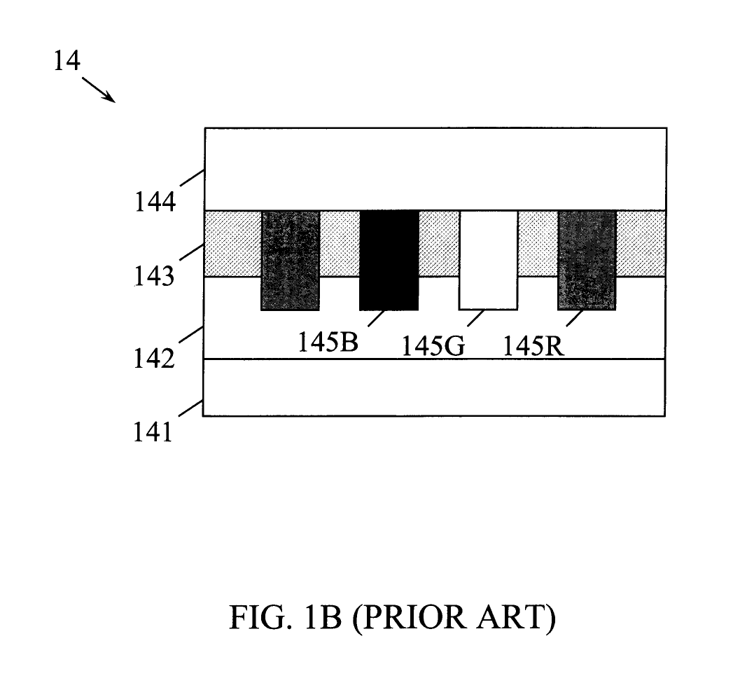

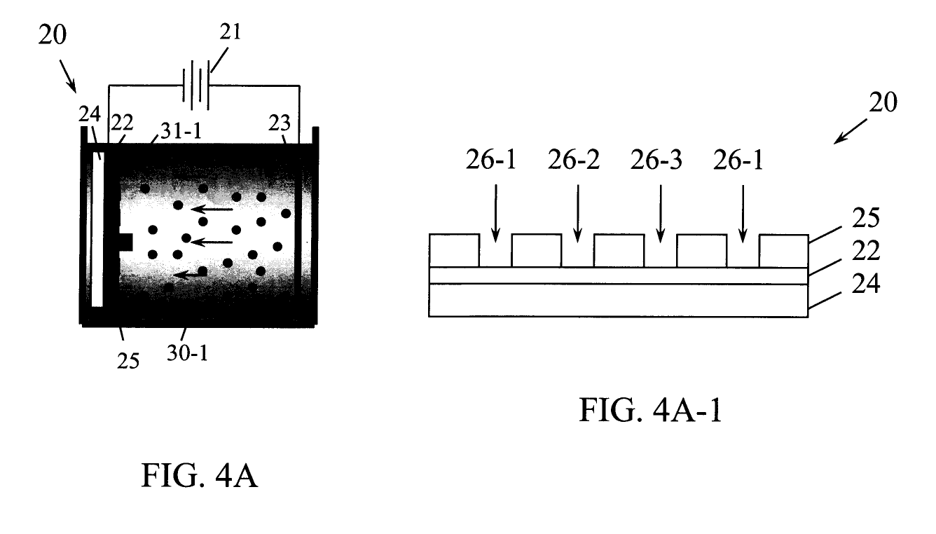

FIGS. 4A to 4C are schematic diagrams illustrating an electrophoretic depositing mechanism for forming a color filter module in accordance with one example of the present invention. Referring to FIG. 4A, a first mixture of a polarized solution such as water and first compound particles 30-1 with a first average diameter may be provided to perform the electrophoretic deposition (EPD). The EPD mechanism may include a counter electrode 23 and a working electrode structure 20. Also referring to FIG. 4A-1, which is an enlarged view of the working electrode structure 20, the working electrode structure 20 may include a transparent substrate 24, a transparent conductive layer 22 on the transparent substrate 24 and a patterned insulating layer 25 on the transparent conductive layer 22. The transparent conductive layer 22 may serve as a working electrode for the EPD mechanism. The patterned insulating layer 25 may be formed by forming an insulating layer over the transparent conductive layer 22 and then removing portions of the insulating layer by, for example, a laser cutting process or photolithography, leaving grooves 26-1 to 26-3 in the patterned insulating layer 25 for subsequent deposition of compound particles. In one example, the patterned insulating layer 25 and the grooves 26-1 to 26-3 may be arranged in a pattern similar to one of the first, second and third patterns shown in FIGS. 2A, 2B and 2C, respectively.

A power source 21 may provide a potential across the transparent working electrode 22 and the counter electrode 23 for approximately one minute, resulting in a first film 31-1 of particles in the grooves 26-1. The surface of a nanoparticle may have a zeta-potential, which may be electrically positive, and therefore the first compound particles 30-1 may move toward the working electrode 22 when the working electrode 22 is negatively biased. In one example according to the preset invention, the first compound particles 30-1 may include CdSe particles and a direct-current (dc) voltage of approximately 5 volts may be applied across the counter electrode 23 and the working electrode 22.

Next, referring to FIG. 4B, a second mixture of a polarized solution and second compound particles 30-2 with a second average diameter may be provided. Similarly, by applying a voltage across the transparent working electrode 22 and the counter electrode 23, a second film 31-2 of particles in the grooves 26-2 may be obtained. In one example, the second compound particles 30-2 may include CdSe particles and the second average diameter may be different from the first average diameter. In another example, the second compound particles 30-2 may be different from the first compound particles 30-1 and may include, for example, PbS particles. In yet another example of the present invention, the patterned insulating layer 25 may be reformed for subsequent deposition of the second compound particles 30-2.

Referring to FIG. 4C, a third mixture of a polarized solution and third compound particles 30-3 with a third average diameter may be provided. Similarly, by applying a voltage across the transparent working electrode 22 and the counter electrode 23, a third film 31-3 of particles in the grooves 26-3 may be obtained. In one example, the third compound particles 30-3 may include CdSe particles and the third average diameter may be different from the first average diameter. In another example, the third compound particles 30-3 may be different from the first compound particles 30-1 and may include, for example, CdS particles. In one example, each of the first film 31-1, second film 31-2 and third film 31-3 may be able to support light emission when deposited to a thickness of approximately 100 nm. In yet another example of the present invention, the patterned insulating layer 25 or the reformed patterned insulating layer may be reformed for subsequent deposition of the third compound particles 30-3.

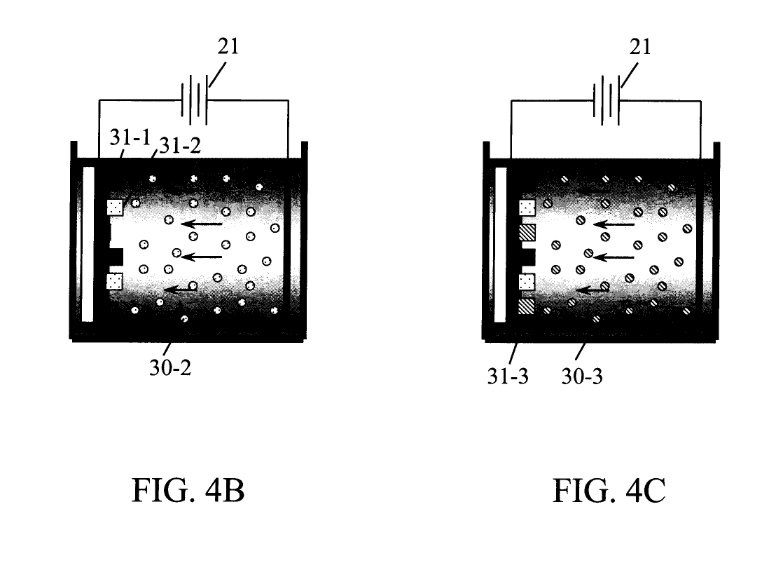

FIGS. 5A to 5D are diagrams illustrating a method of forming a color filter using electrophoretic deposition shown from a cross-sectional view and a top planar view. Referring to FIG. 5A, a substrate 34 such as a glass substrate or a flexible substrate may be provided. A patterned conductive layer 32 may be formed on the substrate 34 by, for example, a deposition process followed by a laser cutting process or photolithography. The substrate 34 on which the patterned conductive layer 32 is formed may then be placed in an EPD mechanism similar to that described and illustrated with reference to FIGS. 4A to 4C, with the patterned conductive layer 32 serving as a working electrode.

Next, a first mixture of a polarized solution such as water and first compound particles with a first average diameter may be provided in the EPD mechanism. Referring to FIG. 5B, by applying a first voltage from a power source 35 to a first set of conductive regions of the patterned layer 32, a first set of color pixels 32-1 may be formed. The first set of color pixels 32-1 may provide a light emission of a first color.

Next, a second mixture of a polarized solution and second compound particles with a second average diameter may be provided in the EPD mechanism. Referring to FIG. 5C, by applying a second voltage from the power source 35 to a second set of conductive regions of the patterned layer 32, a second set of color pixels 32-2 may be formed. The second set of color pixels 32-2 may provide a light emission of a second color.

Next, a third mixture of a polarized solution and third compound particles with a third average diameter may be provided in the EPD mechanism. Referring to FIG. 5D, by applying a third voltage from the power source 35 to a third set of conductive regions of the patterned layer 32, a third set of color pixels 32-3 may be formed. The third set of color pixels 32-3 may provide a light emission of a third color.

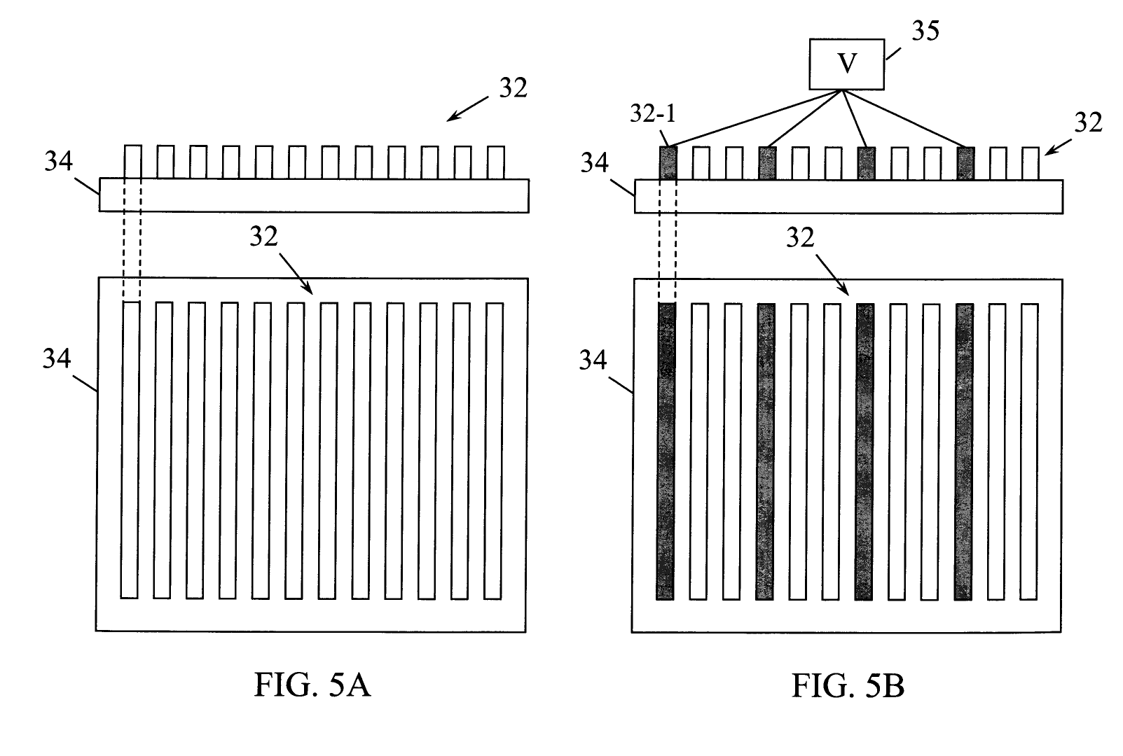

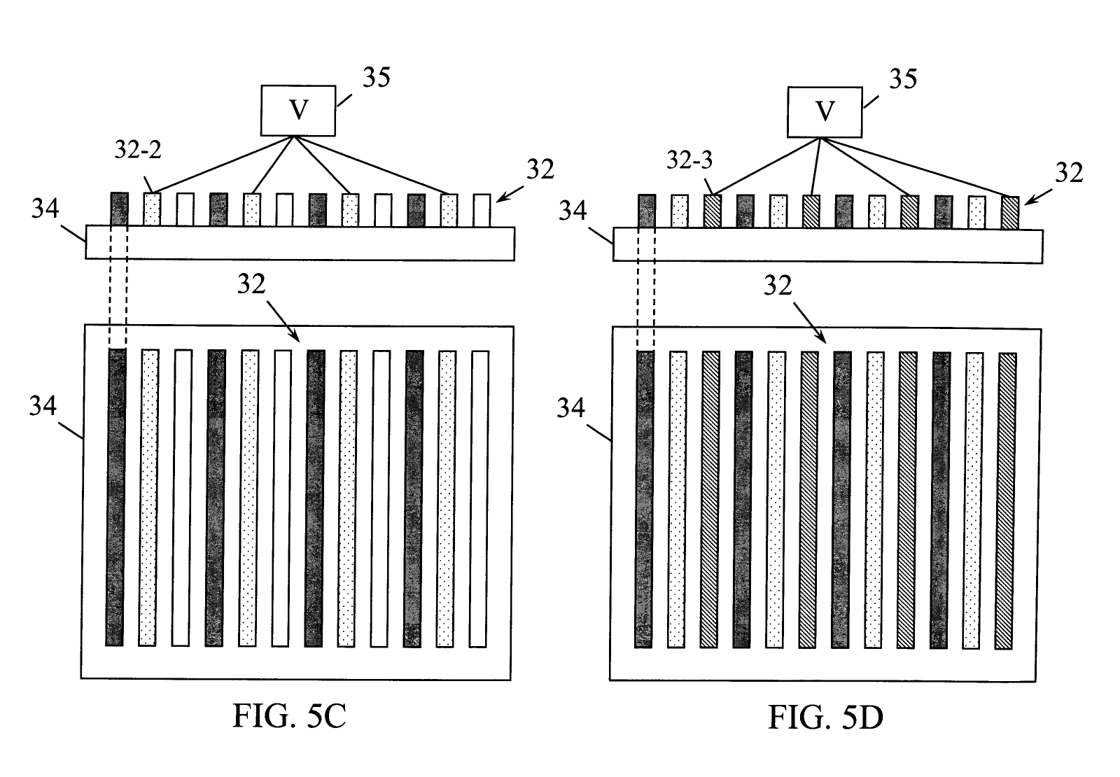

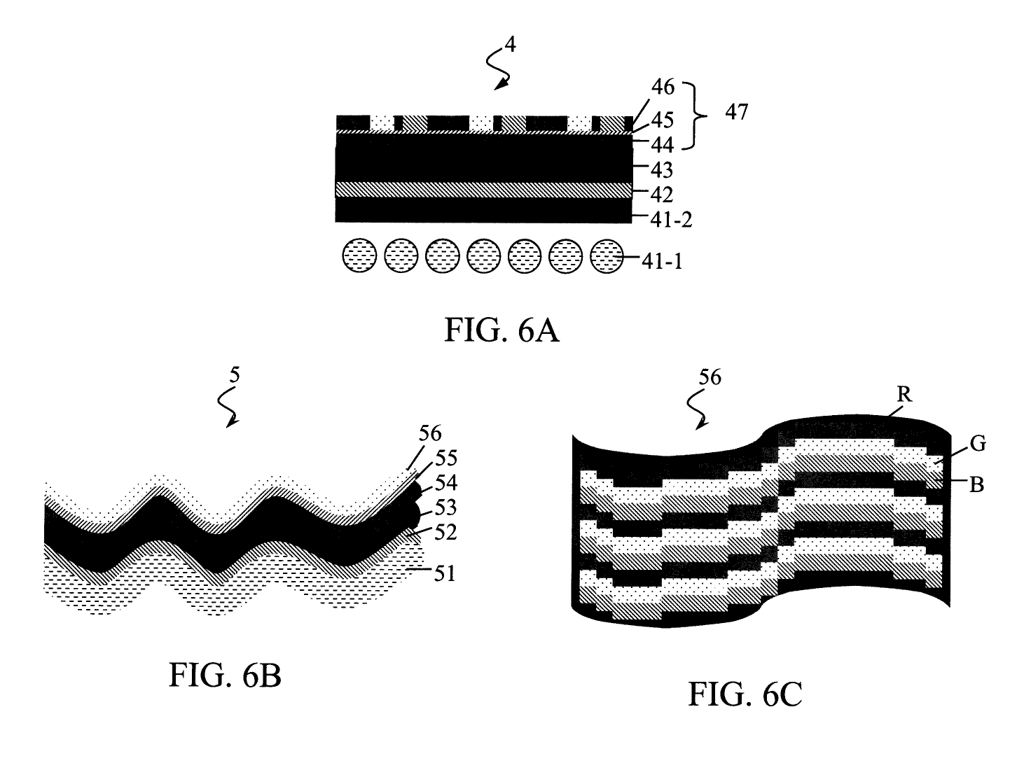

FIG. 6A is a cross-sectional view illustrating a display device 4 in accordance with an example of the present invention. Referring to FIG. 6A, the display device 4 may include a backlight source 41-1, a substrate 41-2, a thin film transistor (TFT) layer 42, a liquid crystal (LC) layer 43 and a color filter 47. The color filter 47, which may be similar to the color filter 200 described and illustrated with reference to FIG. 2A, may further include a substrate 44, a transparent conductive layer 45 and a color layer 46. The color layer 46, which may contain particles of different sizes, may be formed by the electrophoretic depositing method as described and illustrated with reference to FIGS. 4A to 4C. The backlight source 41-1 may include but is not limited to a dot-matrix light source as in the present example or a planar light source. Furthermore, the backlight source 41-1 may emit light such as blue or purple light different from white light. Moreover, the backlight source 41-1 may emit light with a wavelength ranging from approximately 300 to 400 nm.

FIG. 6B is a cross-sectional view illustrating a display device 5 in accordance with another example of the present invention. Referring to FIG. 6B, the display device 5 may include a flexible backlight module 51, a TFT layer 52, an LC layer 53, a flexible substrate 54, a transparent conductive layer 55 and a color layer 56. The display device 5 may be similar to the display device 4 described and illustrated with reference to FIG. 6A except that, for example, the flexible backlight module 51 and the flexible substrate 54 replace the backlight source 41-1 and the substrate 41-2.

FIG. 6C is a schematic diagram illustrating the color layer 56 shown in FIG. 6B in accordance with an example of the present invention. Referring to FIG. 6C, the color layer 56 may have particles of different sizes distributed in a desired pattern so as to emit different color light by the excitation of light from the flexible backlight module 51.

In describing representative examples of the present invention, the specification may have presented the method and/or process of operating the present invention as a particular sequence of steps. However, to the extent that the method or process does not rely on the particular order of steps set forth herein, the method or process should not be limited to the particular sequence of steps described. As one of ordinary skill in the art would appreciate, other sequences of steps may be possible. Therefore, the particular order of the steps set forth in the specification should not be construed as limitations on the claims. In addition, the claims directed to the method and/or process of the present invention should not be limited to the performance of their steps in the order written, and one skilled in the art can readily appreciate that the sequences may be varied and still remain within the spirit and scope of the present invention.

It will be appreciated by those skilled in the art that changes could be made to the examples described above without departing from the broad inventive concept thereof. It is understood, therefore, that this invention is not limited to the particular examples disclosed, but it is intended to cover modifications within the spirit and scope of the present invention as defined by the appended claims.

We claim:

1. A color filter module comprising:
a substrate;
a transparent conductive layer on the substrate;
a set of first particles of a first diameter disposed on first regions of the transparent conductive layer, the first diameter allowing the first regions to provide a first light emission with a first wavelength;
a set of second particles of a second diameter disposed on second regions of the transparent conductive layer, the second diameter allowing the second regions to provide a second light emission with a second wavelength; and
a set of third particles of a third diameter disposed on third regions of the transparent conductive layer, the third diameter allowing the third regions to provide a third light emission with a third wavelength.

2. The color filter module of claim 1, wherein the first, second and third particles are selected from at least one of II-VI compounds or III-V compounds.

3. The color filter module of claim 1, wherein the first, second and third particles are selected from at least one of cadmium selenide (CdSe), cadmium sulfide (CdS), zinc selenide (ZnSe), zinc sulfide (ZnS), cadmium telluride (CdTe), platinum selenide (PtSe), lead sulfide (PbS), indium arsenide (InAs), indium phosphide (InP), PtSe/Te, CdSe/Te, CdSe/ZnSe or CdSe/CdS.

4. The color filter module of claim 1, wherein the first, second and third particles are selected from cadmium selenide (CdSe).

5. The color filter module of claim 4, wherein the first diameter is averagely 7 nanometers, the second diameter is averagely 5 nanometers and the third diameter is averagely 3 nanometers.

6. The color filter module of claim 1, wherein the substrate includes one of a glass substrate and a flexible substrate.

7. A display device comprising:
a light source;
a first substrate to receive light from the light source;
a liquid crystal layer over the first substrate; and
a color layer comprising:
a second substrate;
a transparent conductive layer on the second substrate;
a set of first particles of a first diameter disposed on first regions of the transparent conductive layer, the first diameter allowing the first regions to provide a first light emission with a first wavelength;
a set of second particles of a second diameter disposed on second regions of the transparent conductive layer, the second diameter allowing the second regions to provide a second light emission with a second wavelength; and
a set of third particles of a third diameter disposed on third regions of the transparent conductive layer, the third diameter allowing the third regions to provide a third light emission with a third wavelength.

8. The display device of claim 7, wherein the first, second and third particles are selected from at least one of II-VI compounds or III-V compounds.

9. The display device of claim 7, wherein the first, second and third particles are selected from at least one of cadmium selenide (CdSe), cadmium sulfide (CdS), zinc selenide (ZnSe), zinc sulfide (ZnS), cadmium telluride (CdTe), platinum selenide (PtSe), lead sulfide (PbS), indium arsenide (InAs), indium phosphide (InP), PtSe/Te, CdSe/Te, CdSe/ZnSe or CdSe/CdS.

10. The display device of claim 7, wherein the first, second and third particles are selected from cadmium selenide (CdSe).

11. The display device of claim 10, wherein the first diameter is averagely 7 nanometers, the second diameter is averagely 5 nanometers and the third diameter is averagely 3 nanometers.

12. The display device of claim 7, wherein the first substrate and the second substrate include one of a glass substrate and a flexible substrate.

13. The display device of claim 7, wherein the light source provides a light emission with a wavelength ranging from 300 nm to 400 nm.

14. A display device comprising:
a light emission layer;
a thin film transistor layer over the light emission layer;
a liquid crystal layer over the thin film transistor layer; and
a color layer comprising:
a substrate;
a transparent conductive layer on the substrate;
a set of first particles of a first diameter disposed on first regions of the transparent conductive layer, the first diameter allowing the first regions to provide a first light emission with a first wavelength;
a set of second particles of a second diameter disposed on second regions of the transparent conductive layer, the second diameter allowing the second regions to provide a second light emission with a second wavelength; and
a set of third particles of a third diameter disposed on third regions of the transparent conductive layer, the third diameter allowing the third regions to provide a third light emission with a third wavelength.

15. The display device of claim 14, wherein the first, second and third particles are selected from at least one of II-VI compounds or III-V compounds.

16. The display device of claim 14, wherein the first, second and third particles are selected from at least one of cadmium selenide (CdSe), cadmium sulfide (CdS), zinc selenide (ZnSe), zinc sulfide (ZnS), cadmium telluride (CdTe), platinum selenide (PtSe), lead sulfide (PbS), indium arsenide (InAs), indium phosphide (InP), PtSe/Te, CdSe/Te, CdSe/ZnSe or CdSe/CdS.

17. The display device of claim 14, wherein the first, second and third particles are selected from cadmium selenide (CdSe).

18. The display device of claim 17, wherein the first diameter is averagely 7 nanometers, the second diameter is averagely 5 nanometers and the third diameter is averagely 3 nanometers.

19. The display device of claim 14, wherein the light emission layer and the substrate include one of a glass substrate and a flexible substrate.

20. The display device of claim 14, wherein the light emission layer radiates light having a wavelength ranging from 300 to 400 nm.
